(19) United States
(12) Patent Application Publication
(10) Pub. No.: US 2005/0093207 A1
(43) Pub. Date: May 5, 2005

(54) Injection molding lid transfer apparatus and method

(76) Inventors: John Di Simone, Woodbridge (CA); Barry Lloyd Drysdale, Puslinch (CA)

Correspondence Address: KATTEN MUCHIN ZAVIS ROSENMAN, 525 WEST MONROE STREET, CHICAGO, IL, 60661-3693, US

(21) Appl. No.: 10/695,801

(22) Filed: Oct. 30, 2003

(51) Int. Cl. B29C 45/42

(52) U.S. Cl. 264/328.1; 425/556; 425/317

(57) ABSTRACT

A simple and flexible lid molding system is provided that is generally capable of maintaining a high productivity workflow coupling between an injection mold and a lid stacking operation, or other such downstream process. The lid molding system includes a lid conveyor that cooperates with an in-mold part handling system. The lid conveyor furthermore accommodates lids of generally any size and shape, and is capable of conveying the lids along generally any path and through any distance.

### BACKGROUND OF INVENTION

1. Field of the Invention

The present invention relates, generally, to a molding system for the production of molded plastic articles, and more particularly, but not exclusively, the invention relates to a molding system for the production of container lids, and to a lid conveyor for use in the molding system for linking an injection molding machine with a lid packing station.

2. Background Information

A commonly used system for supporting a high-volume production of injection molded lids includes: a high cavitation multi-level stack mold operating in an injection molding machine that ejects lids formed therein directly onto a typical horizontal conveyor; the conveyor feeds the randomly oriented lids into a lid stacking system; the lid stacking system then orients, stacks, and bags the lids as required. The lid stacking system 20 is shown in FIG. 1, and includes: a spin bowl 22 to separate and orient the lids 12 (i.e. in a vertical orientation) by the action of spinning the bowl 22 at a reasonably high velocity wherein the lids 12 are forced up against an inside wall of the bowl 22 whereupon the lids 12 are deflected into a linear guide 23 in a vertical orientation; the linear guide 23 directs the vertically oriented lids onto an inclined conveyor 26, and a flipping device 24 at the exit of the linear guide 23 ensures that the lids 12 are being ejected onto a horizontal belt of the conveyor 26 in a common horizontal orientation (i.e. all the lids face upwards or downwards) the lids 12 then travel up and off of the conveyor and onto a lid stacker 28; the lid stacker uses a pair of spin bars to stack the lids 14 for subsequent handling. This lid stacking system is described in more detail in U.S. Pat. No. 5,863,177.

A fundamental shortcoming of such a lid molding system is the inherent cost and complexity of a machine designed in large part to reacquire a common lid orientation (i.e. the spin bowl, linear guide, and flipping device) in view of the potential to preserve the lid orientation directly from the injection mold. The system is known to experience periodic nesting and mis-orientation of lids that limits its efficiency or that of any downstream packaging operations.

A lid molding system wherein lid orientation is preserved from the injection mold to a lid stacking system is described in U.S. Pat. No. 5,037,597. As shown in FIG. 2, the lid molding system includes an injection molding machine 30 coupled to a lid stacking system 20. The injection molding machine 30 includes an injection unit 32, and a clamp unit 34, as is commonly known. A multi-level stack injection mold 36 is mounted in the clamp unit 34 for the production of a plurality of lids 12. The patent discloses the use of an in-mold lid handling system (not shown) wherein swing-chutes are rotated to an inboard position on the molding face (in the mold open position) to retrieve lids 12 and for the transport thereof to an outboard position for engagement with a guide chute (not shown) upon the closing of the mold 36. Thereafter, the lids 12 drop down and exit the guide chutes and into the lid stacking system 20 through chute extensions 38 under the influence of gravity. The lids 12 generally roll through the chute extension 38 on a peripheral edge of the lid 12 and in a substantially vertical orientation. To ensure that the lids 12 have enough gravitational potential to transit the length of the chute extension 38, between the guide chutes of the injection mold 36 and a lid stacker 40 of the lid stacking system 20, the supporting base 35 of the injection molding machine 30 is substantially elevated, to a non-standard, vertical height. The elevation of the injection molding machine 30 is provided by arranging stands 37 beneath the supporting base 35. Once the lids 12 have been transferred into the lid stacking system, a series of lid stackers, typically spin bars, stack the lids whereupon a transfer station handles the stacked lids 14 onto a linear conveyor for downstream bagging or use.

While this lid molding system provides a simple link between the injection mold 36 and the lid stacking station 20 that preserves the orientation of the lid 12, it does lack flexibility as the lid stacking system 20 must be positioned immediately adjacent the injection mold 36. This may be at the expense of an efficient or optimal workflow.

Furthermore, the injection molding machine requires an elevated supporting base that would invoke additional costs associated with a non-standard injection molding machine base, increased complexity for mold 36 installation and maintenance, the possibility of having to modify existing plant services and molding material connections, and the required height may simply be unavailable in many molding plants. In addition, the system may have difficulty in handling non-round lids because of their inability to roll through the chute extension 38.

U.S. Pat. Nos. 4,391,560, 3,741,366, and 3,938;675 all provide further examples of article molding systems that injection mold and stack plastic articles. Each of these systems requires some sort of preliminary operation to reacquire a common orientation of the articles prior to stacking.

Hence, there is a need for a simple and flexible lid molding system. More particularly, there is a need for a lid conveyor that is capable of maintaining a high productivity workflow coupling between a high-productivity injection mold and a lid stacking or other such downstream operation. Such a system would accommodate a conveyance distance and path that supports an optimal workflow, integrate standard equipment (i.e. injection molding machine and lid stacking), and accommodate lids of generally any size and shape.

### SUMMARY OF THE INVENTION

The present invention provides a simple and flexible lid molding system that is generally capable of maintaining a high productivity workflow coupling between an injection molding system and a lid stacking operation, or other such downstream process.

The lid molding system includes a lid conveyor that cooperates with an in-mold part handling system. The lid conveyor furthermore accommodates lids of generally any size and shape, and is capable of conveying the lids along generally any path and through any distance.

In accordance with an aspect of the invention, a lid molding system includes an injection molding machine for the production of lids. The injection molding machine including an injection unit, an injection molding machine clamp unit with an injection mold mounted therein. The injection mold including an in-mold lid handling system mounted thereto that includes at least one guide chute. The lid molding system further includes a lid conveyor positioned beneath the injection molding machine clamp unit to align and engage with the at least one guide chute when the injection mold is in a closed position. The lid conveyor including means for lid guiding and means for lid driving wherein the lid conveyor, in use, receives lids from the guide chute of the in-mold lid handling system for conveying the lids to a downstream process in a generally vertical orientation.

The lid molding system may further include a lid packing station for the stacking and packaging of the lids, or may simply include a lid stacker for stacking the lids for subsequent handling.

In accordance with another aspect of the invention, a lid conveyor is provided that comprises a means for lid guiding that, in use, maintains a lid being guided therein in a generally vertical orientation, and a means for lid driving that is configured to engage, in use, a peripheral portion of the lid for transporting the lid therewith.

In a preferred embodiment, the means for lid driving is a provided by a re-circulating chain driven by a drive assembly wherein the chain includes a plurality of chain links connected by linking pins. Each of the chain links includes substantially parallel and spaced apart link members that are connected by a cylindrical spacer at an end thereof. The chain engages a peripheral portion of the lid in a space provided between the cylindrical spacers between adjacent chain links.

In accordance with an alternative embodiment of the invention, the chain may further include a plurality of engagement members attached thereto for engaging the peripheral portion of the lid.

In accordance with another aspect of the invention, a method for lid molding is provided that includes the steps of:
i) Molding a plurality of lids in an injection molding machine;
ii) Opening the injection mold to reveal the lids;
iii) Retrieving the lids from the injection mold using an in-mold lid handling system;
iv) Transferring the lids into at least one guide chute mounted to the injection mold using the in-mold lid handling system;
v) Closing and clamping of the injection mold;
vi) Substantially simultaneously to molding a subsequent plurality of lids, releasing the lids held in the at least one guide chute from the in-mold lid handling system so that the lids drop therein under the force of gravity;
vii) Transferring the lids into at least one lid conveyors that are aligned with the at least one guide chute beneath the at least drop chute in the mold closed position in a substantially vertical orientation;
viii) Conveying the lids to a downstream process.

The method may further include the step of conveying the lids to a lid packing station, or to at least one lid stacker.

### BRIEF DESCRIPTION OF THE DRAWINGS

Exemplary embodiments of the present invention will now be described with reference to the accompanying drawings, in which:

FIG. 1 is a perspective view of a known lid stacking system;

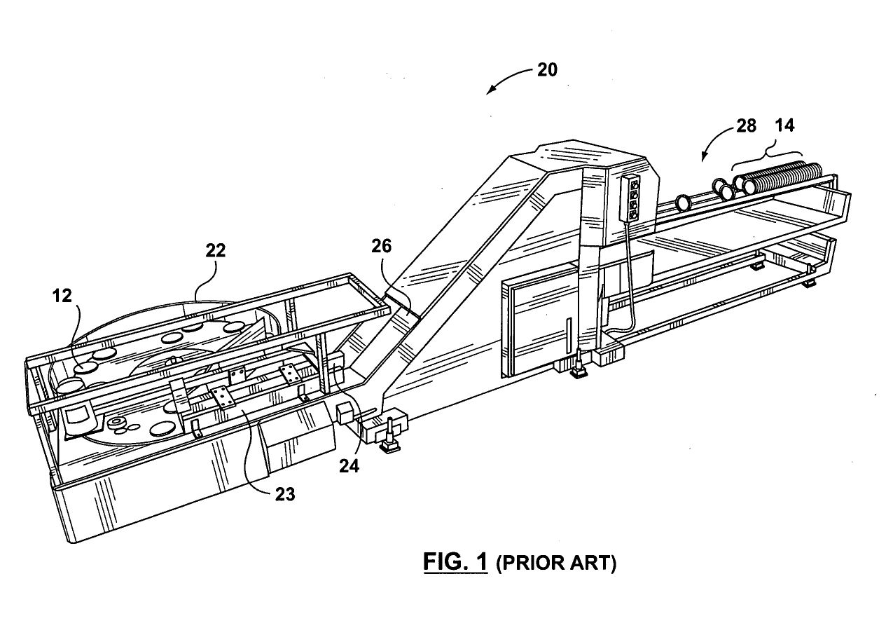

FIG. 2 is a perspective view of another known lid molding system;

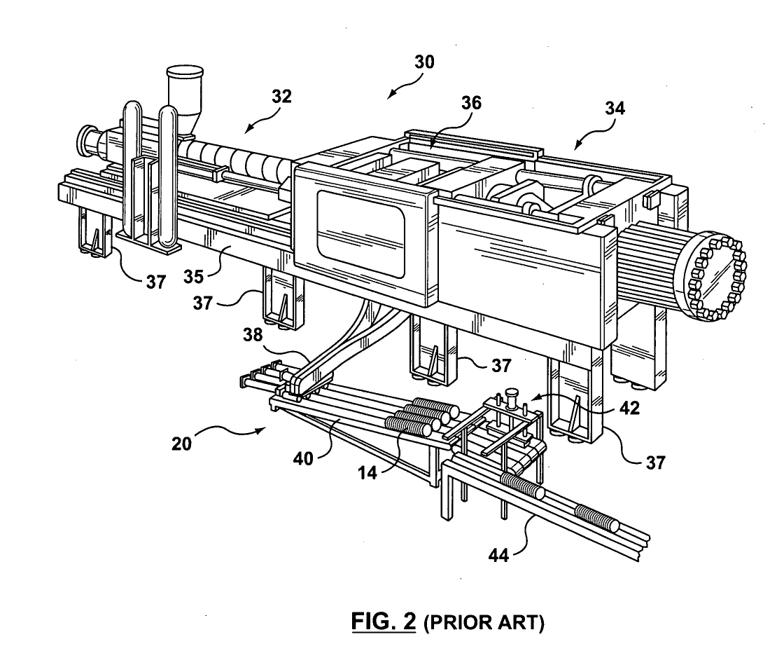

FIG. 3 is a perspective view of a lid molding system according to a preferred embodiment of the present invention;

FIG. 4 is a plan view of a lid molding system of FIG. 3;

FIG. 5 is a close-up perspective view of the lid packing station used in the lid molding system of FIG. 3;

FIG. 6 is a side view of a representative portion of the lid conveyor used in the lid molding system of FIG. 3;

FIG. 7 is a perspective view illustrating the engagement of a peripheral portion of the lid with a chain used in the lid conveyor used of FIG. 6;

FIG. 8 is a cross sectional view of a lid conveyor at the section line 8-8 as shown in FIG. 6;

FIG. 9 is a plan view of the representative portion of the lid conveyor of FIG. 6;

FIG. 10 is a perspective view of a lid molding system according to an alternative embodiment of the present invention.

### DETAILED DESCRIPTION OF THE PRESENTLY PREFERRED EXEMPLARY EMBODIMENT

Referring to FIG.(s) 3, 4, & 5, a lid molding system in accordance with a preferred embodiment of the present invention is shown. The molding system includes an injection molding machine clamp unit 34 with a 4-level lid stack mold 36 mounted therein between a stationary platen 50 and a moving platen 52. The injection molding machine, clamp unit 34, and mold 36 being operable as commonly known. The clamp unit is also shown as including a clamp assembly for operating the injection mold 36 between an open, closed, and clamped configuration, as generally described in U.S. Pat. No. Re 37,827. The injection mold 36 is configured for high-volume, efficient lid production and accordingly includes an in-mold lid handling means.

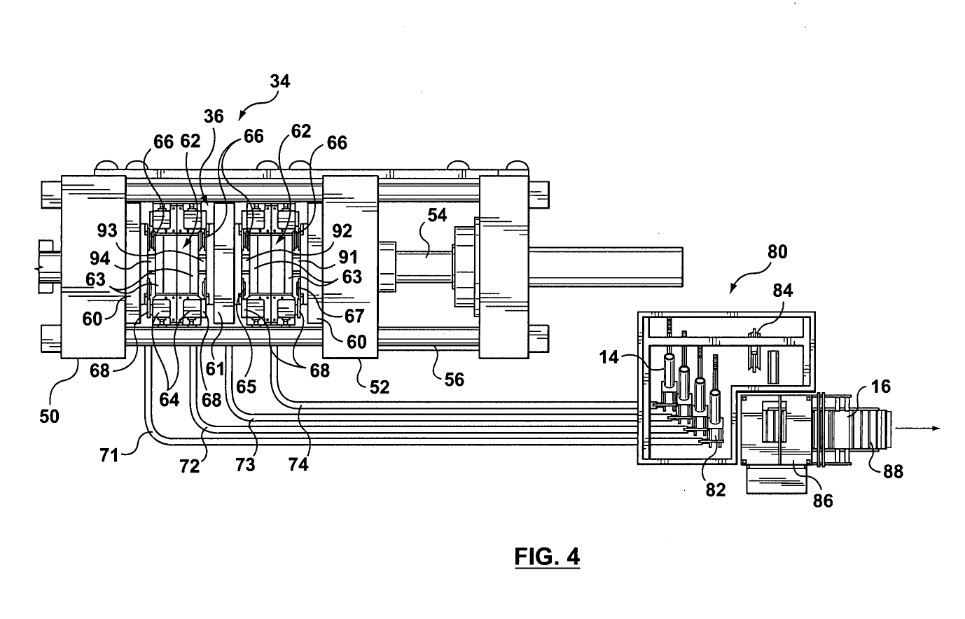

With reference to FIG. 4, the 4-level stack mold 36 is shown in detail. The injection mold includes four molding faces 91, 92, 93, 94, and each molding face further includes a pair of parallel rows of molding cavities. Each molding face 91, 92, 93, 94 is provided by a core plate assembly 60, 61 that cooperates with a corresponding cavity plate assembly 63. The core plate assemblies 60, 61 are provided by a center core plate 61, and two single molding face core plate assemblies 60 mounted on the stationary and moving platens respectively. The faces of the core plate assemblies 60, 61 adjacent the molding faces 91, 92, 93, & 94 include core molding inserts 65 that form a portion of the molding cavities. The cavity plate assemblies 63 also include cavity molding inserts 67 that form the complementary portion of the molding cavities. The cavity plate assemblies 63 are provided in pairs between the core plate assemblies 60, 61, each pair of cavity plate assemblies 63 being separated by a common hot runner section 62. The hot runner section 62 is provided with a sprue (not shown) for coupling with the injection unit (not shown) of the injection molding machine. Each hot runner section 62 further supports the in-mold part handling system.

The in-mold part handling system includes a plurality of side shuttles 66, each of which is operable to translate laterally across the molding faces 91, 92, 93, and 94 to retrieve a plurality of lids 12 from the rows of core molding inserts 65 and to thereafter transport the lids 12 to guide chutes 68. The step of retrieving the lids from the mold includes: positioning of the plurality of side shuttles 66 adjacent an exposed front face of the plurality of lids 12 that are still being held on the core molding inserts 65; and ejecting the plurality of lids 12 from the core molding inserts 65 onto a plurality of coupling members (not shown) that are arranged on the plurality of side shuttles, the ejection action being provided by a plurality of mold stripper rings (not shown) provided on the core plate assemblies. A guide chutes 68 is provided for each side shuttle 66. The guide chutes 68 are shown mounted to the hot runner section 62 adjacent the cavity plate assembly 63, and are oriented generally parallel to the row of molding cavities being serviced. Each side shuttle 66 is driven and guided by means provided on the hot runner section 62 of the injection mold 36. Each side shuttle is preferably driven through the use of a servo motor 64 and a transmission means (not shown). The detailed construction and operation of the side shuttle in-mold part handing system is provided in co-pending U.S. patent application Ser. No. 10/287,809. Of course, alternative in-mold part handling systems could be used, such as swing chutes described in U.S. Pat. No. 5,518,387. Of course, the number and locations of the shuttles may be varied depending upon the specific injection molding machine.

Four lanes of lid conveyors 71, 72, 73, 74 are shown with a dedicated lid conveyor lane servicing both guide chutes 68 of each molding face 91, 92, 93, 94. Each lane of lid conveyors 71, 72, 73, 74 are positioned beneath the injection molding machine clamp unit 34 to align and engage with the corresponding guide chutes 68 in a mold closed position. The construction and operation of the lid conveyors 71, 72, 73, 74 is described in more detail hereinafter.

In an alternative embodiment of the invention, a gate (not shown) positioned at the exit of the guide chutes 68 may be provided for sequencing the transfer of the lids 12 from each of the guide chutes 68 serviced by a lid conveyor, or each guide chute may be provided with a dedicated lid conveyor.

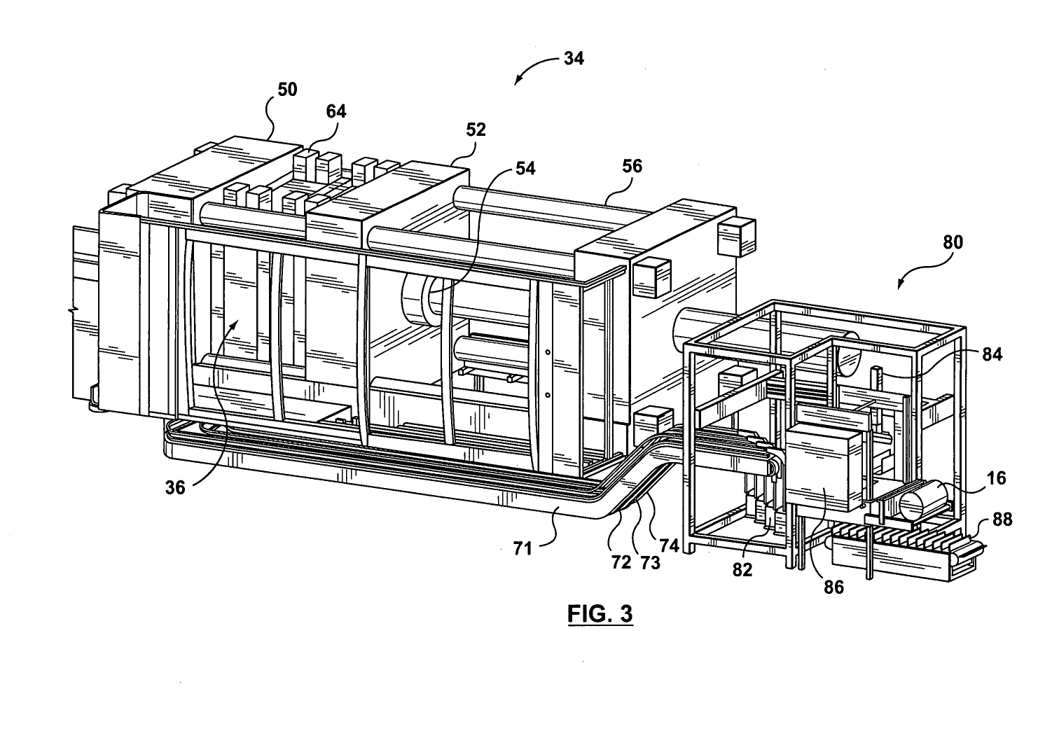

In operation, once the lids 12 have been transported into the guide chutes 68, and upon mold closing, the side shuttles 66 releases the lids 12. Thereafter, the lids 12 drop down the guide chutes 66, under the force of gravity, and into lid conveyors 71, 72, 73, and 74 in a substantially vertical orientation, that is on their peripheral edge. The lid conveyors 71, 72, 73, 74 maintain the lids in a generally vertical orientation during their transport to maintain proper engagement therewith. An advantage to conveying the lids 12 in a vertical orientation is that the lanes of lid conveyors 71, 72, 73, 74 can be spaced closely together which saves on the overall size of the molding system. Another advantage of the lid conveyors 71, 72, 73, 74 is its ability to transport the plurality of lids 12 along a path that includes corners and inclines and is therefore generally adaptable to any desired path. In particular, because the path of the lid conveyor 71, 72, 73, 74 can be inclined it can be used with an injection molding machine that provides only minimal clearance beneath the injection mold 36. As shown in FIG. 3, the path taken by the lid conveyors 71, 72, 73, 74 routes the lids retrieved from beneath the injection mold 36 directly away from the injection molding machine clamp unit 36, generally at right angles to its longitudinal axis, until the lid conveyors run out from beneath the machine clamp unit 34 whereupon the path turns through a 90 degree radius and then runs parallel to the machine clamp unit 34 along its length, the path is then inclined to raise the height of the lids 12 for subsequent transfer to a lid packing station 80 positioned behind the injection molding machine clamp unit 34.

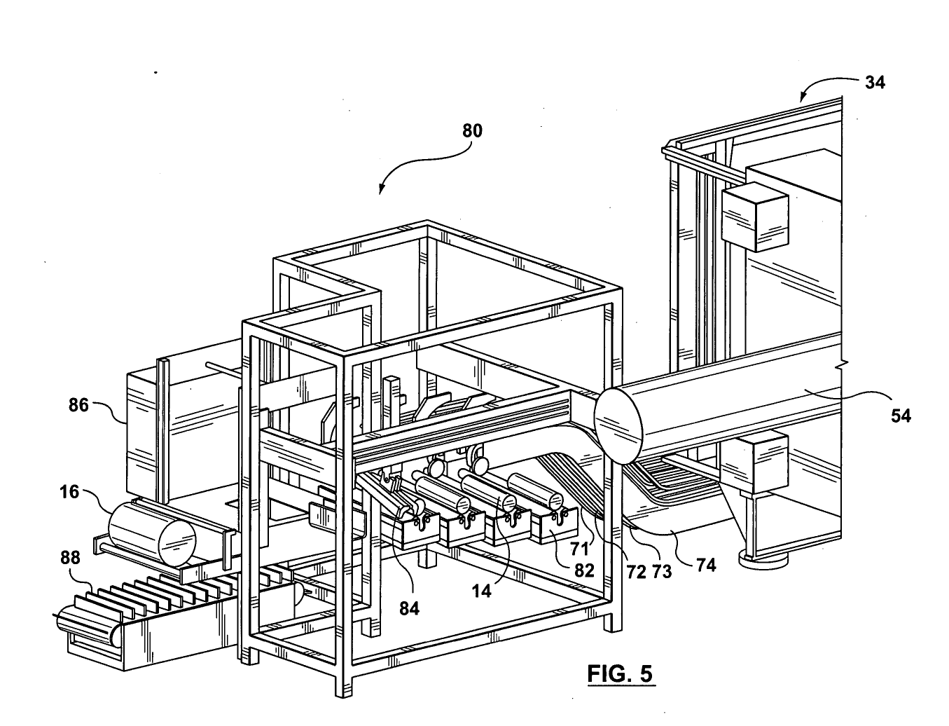

The lid packing station, shown in detail with reference to FIG. 5, incorporates commonly known sub-systems. In particular, the lid packing station 80 includes a series of spin-bar lid stackers 82, one for each lane of lid conveyor 71, 72, 73, 74, for stacking the lids 12, thereafter the stacked lids 14 are transferred by means of a transfer robot 84 to a bagger 86 that bags and ejects the packaged stack of lids 16 onto a conveyor 88 for downstream handling into boxes.

The structure of the lid conveyor 71, 72, 73, 74 will now be described with reference to FIG.(s) 6, 7, 8 & 9. The basic structure of the lid conveyor 71, 72, 73, 74 is provided by a set of guides which maintain the vertical orientation of the molded lid 12, and a lid driving means for transporting the lid 12 along the-conveyor path, the lid 12 engaging the driving means about a peripheral portion thereof.

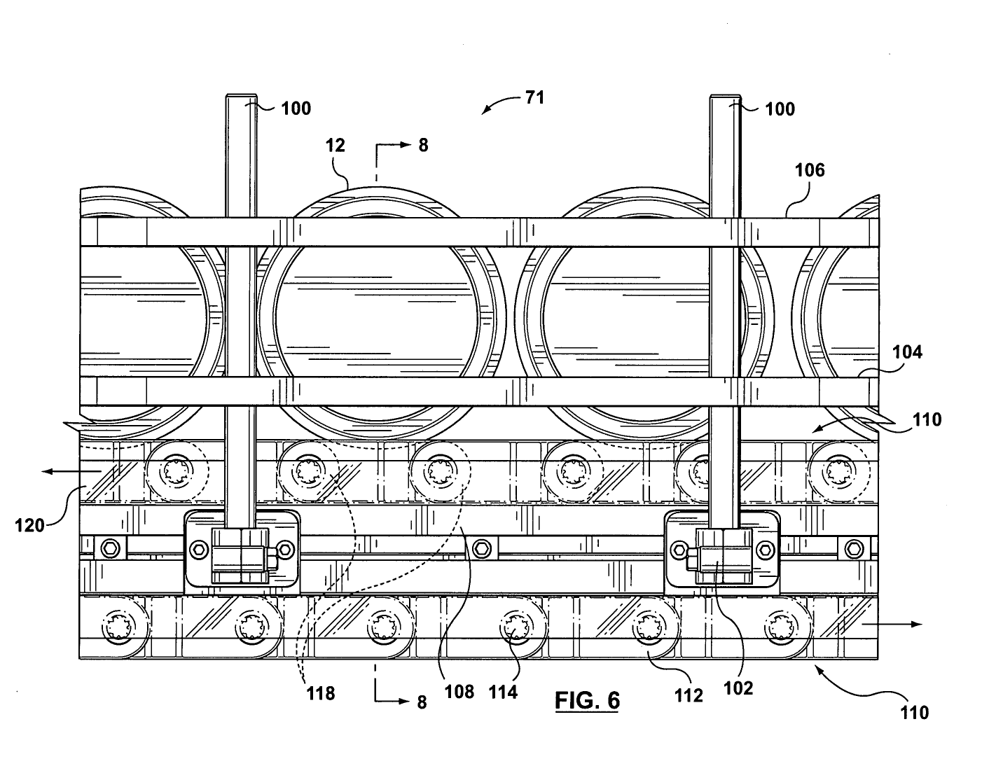

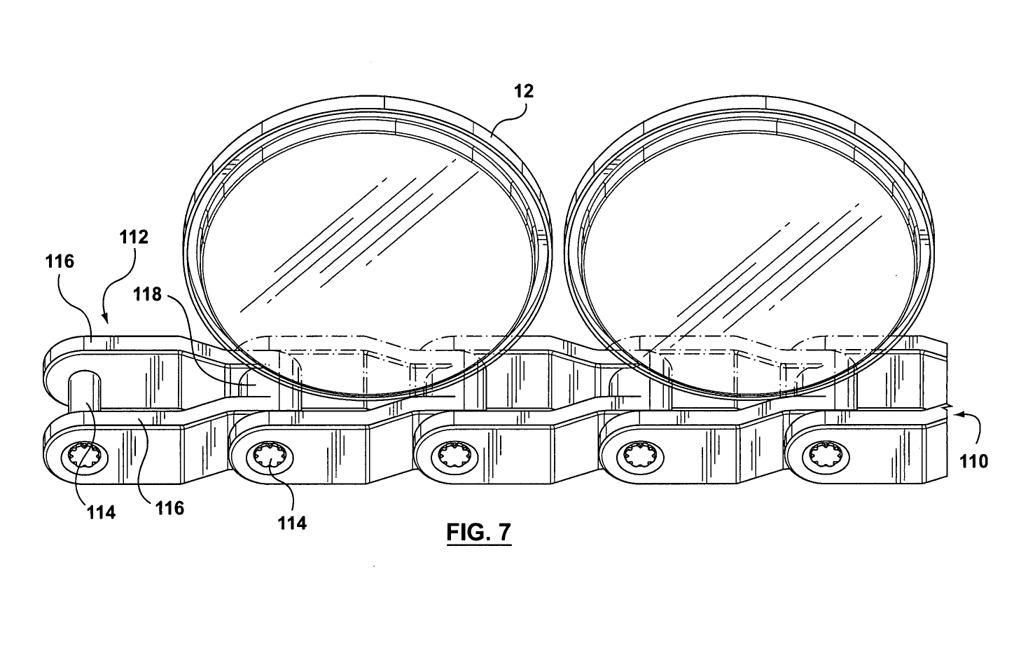

The lid driving means is preferably provided by a re-circulating chain 110 driven by a drive assembly (not shown). As shown in FIG. 7, a typical chain link 112 in the chain 110 includes substantially parallel and spaced apart link members 116 that are connected by a cylindrical spacer 118 at an end thereof. Adjacent chain links 12 are connected together into the chain 110 by linking cotter pins 114 that engage a cylindrical bore (not shown) that passes through the ends of the link members 116 and the center of the cylindrical spacer 118 in proximity to the ends of the chain link 112. The diameter of the cylindrical bore (not shown) through the cylindrical spacer 118 includes additional clearance to the cotter pin 114 for the purpose of increasing the flexibility of the chain 110. Similarly, there is provided a generally loose fit between a narrowed portion of the chain link 112 that fits in between the link members 118 of the adjacent chain link 112. In use, a peripheral portion of the lid 12 engages the chain 110 in the space provided between the cylindrical spacers 118 between adjacent chain links 112, as shown in FIG. 6, and 7.

The structure of a chain 110 provides an advantageous lid driving means given its three dimensional flexibility, albeit relatively limited in a direction that is generally perpendicular to the rotational axis of the cotter pin 114. In particular, varieties of chain are available that are capable of conforming to a conveyance path in substantially any direction. Of particular importance in the selection of a chain is to choose a chain that accommodates curvature in the conveyance path.

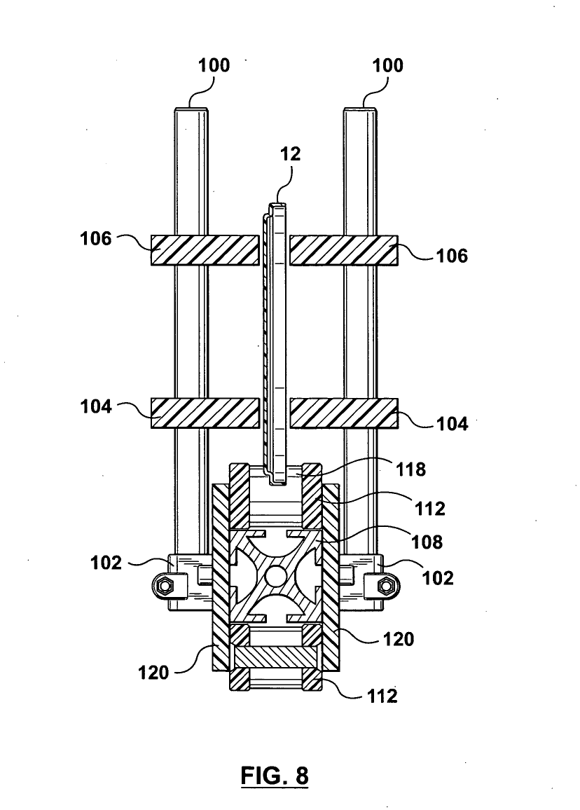

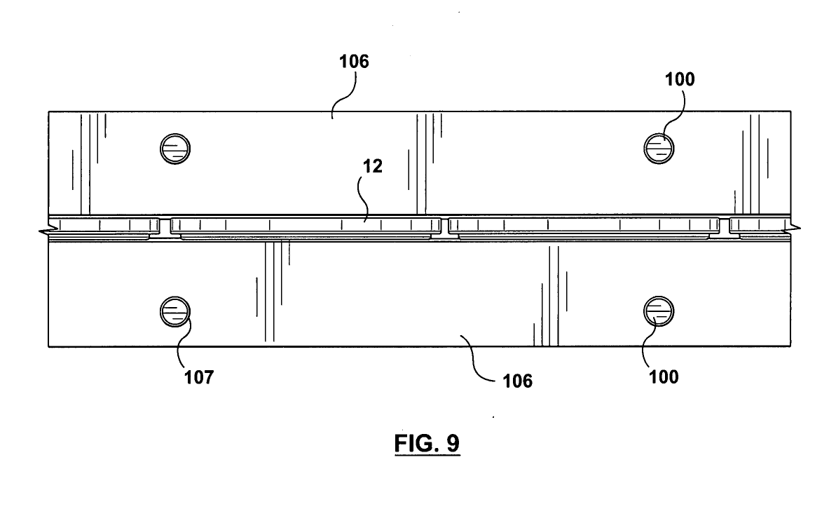

The cross-sectional structure of the lid conveyor 71, 72, 73, 74, as shown in FIG. 8, will now be described in further detail. The structure of the lid conveyor 71, 72, 73, 74 includes an elongate channel member 108 that provides a base frame for the conveyor, and is shaped in accordance with the required path of the lid conveyor. The channel member 108 includes upper and lower surfaces that in conjunction with chain guides 120 provide a channel for guiding the chain guide along the conveyance path. The chain guides 120 are mounted on either side of the channel member 120 and extend above and below the upper and lower surface thereof. The guides for maintaining the vertical orientation of the molded lid 12 are provided as upper 106 and lower guides 104 that are positioned on both sides of the lid conveyance path. The upper 106 and lower guides 104 extend along the length of the conveyance path and may be provided in segmented sections. The provision of an upper 106 and a lower guide 104 ensures that the molded lid 12 remains vertically oriented and therefore properly engaged in the chain 110. The upper 106 and lower guides 104 are positioned through the use of cylindrical guide posts 100 which are clamped to the channel member 108 by post clamps 102 that are mounted to the outside surface of the chain guides 120. With reference to FIG. 9, it can be seen that the guide posts 100 interferingly engage cylindrical passages 107 provided in the upper 106 and lower guides 104. The vertical position of the guides 104, 106 can be adjusted by sliding the guides 104, 106 along the guide posts 100. A required horizontal clearance between the guides 104, 106 and the molded lid 12 can be provided sizing the guides accordingly. For improved flexibility, adjustability in the horizontal positioning of the upper guide 106 and lower guides 104 could be incorporated such that the guides 104, 106 need not be replaced for different lid 12 shapes. For example, the horizontal positioning of the guides 104, 106 could be provided by a variant guide post clamp 102 that includes a slotted base. Alternatively, the upper 106 and lower guides 104 could be modified to include slotted channels in place of the cylindrical passages 107, the slots extending generally perpendicular to the direction of travel of the conveyor, for engaging the guide posts 100. A set screw could also be provided to lock upper 106 and lower guides 104 to the guide posts 100 once properly positioned. The adjustable upper 106 and lower guide members ensure complete system flexibility wherein lids of generally any size or shape can be accommodated without having to manufacture lid specific components.

When the spacing between the cylindrical portions 118 of available chain 110 does not accommodate a suitable engagement with the peripheral portion of a lid 12, by virtue of the diameter or the shape of the lid 12, lid engagement members (not shown) could be attached to the chain 110 at a suitable pitch distance to engage the outer peripheral surface of the molded lid 12. Other possible lid driving means could include, for example, a cable or a belt with lid engagement members provided thereon.

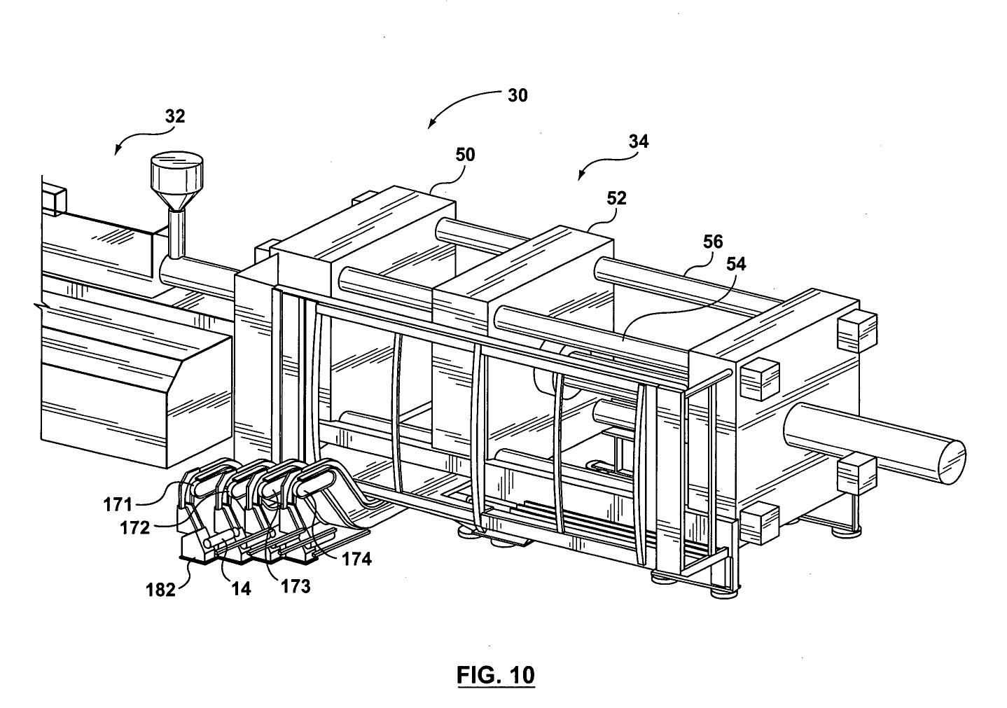

An alternative lid molding system incorporating the lid conveyors 171, 172, 173, 174 in accordance with the present invention, is shown FIG. 10. The lid molding system is. configured for manual offload of stacked lids 14. As described hereinbefore, the lids 12 are transferred, in a substantially vertical orientation, from the guide chutes 68 of the injection mold 36 to lanes of lid conveyors 171,172, 173, 174 arranged beneath the injection molding machine 30. The path of the lid conveyors 171, 172,173,174 routes the lids 12 from beneath the injection mold 36 directly away from the injection molding machine 30 and then along an inclined portion to raise the height of the lids 12 for subsequent transfer to a bank of lid stackers 182. The lid stackers 182 shown use screw means to stack the lids, as generally described in U.S. Pat. No. 3,741,366, although other commercially available lid stackers, such as spin-bars, could otherwise be used in its place. The present lid molding system is simple, efficient, and may be retrofitted for use with an injection molding machine 30 with a minimum of vertical clearance beneath the injection mold 36.

All U.S. and foreign patent documents discussed above are hereby incorporated by reference into the Detailed Description of the Preferred Embodiment.

The individual components shown in outline or designated by blocks in the attached Drawings are all well-known in the molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A lid molding system comprising:
an injection molding machine including:
an injection unit; and
an injection molding machine clamp unit with an injection mold mounted therein; and
the injection mold including an in-mold lid handling system mounted thereto that includes at least one guide chute;
a lid conveyor positioned beneath the injection molding machine clamp unit to align and engage with the at least one guide chute when the injection mold is in a closed position;
the lid conveyor including means for lid guiding and means for lid driving;
wherein the lid conveyor is configured to receive lids from the guide chute of the in-mold lid handling system for conveying the lids in a substantially vertical orientation.

2. The lid molding system according to claim 1, wherein the injection mold comprises a multi-level stack mold having a plurality of molding faces, each molding face including a plurality of rows of molding cavities thereon.

3. The lid molding system according to claim 2, wherein the in-mold part handling system includes at least one side shuttle on each of the molding faces that is operable to translate laterally across the molding faces to transfer a plurality of lids from the rows of molding cavities to at least one guide chute.

4. The lid molding system according to claim 3, wherein a guide chute is dedicated to each side shuttle.

5. The lid molding system according to claim 4, wherein a side shuttle is dedicated to each row of molding cavities.

6. The lid molding system according to claim 5, wherein a lid conveyor is dedicated to service all of the guide chutes of each molding face.

7. The lid molding system according to claim 6, further comprising a gate positioned beneath an exit of the guide chute to provide a sequenced transfer of the lids to the lid conveyor.

8. The lid molding system according to claim 5, wherein a guide chutes is dedicated to each side shuttle.

9. The lid molding system according to claim 1, further including a lid packing station

10. The lid molding system according to claim 9, wherein the lid packing station includes at least one lid stacker for stacking the lids.

11. The lid molding system according to claim 10, wherein the lid packing station further includes a transfer robot and a bagger, the transfer robot transferring the stacked lids from the lid stacker to the bagger.

12. The lid molding system according to claim 11, wherein the lid packing station further includes a conveyor for configured to convey the stacked and bagged lids ejected from the bagger.

13. A lid conveyor comprising:
a means for lid guiding configured to maintain a lid being guided therein in a non-rotating substantially vertical orientation; and
a means for lid driving that is configured to engage, in use, a peripheral portion of the lid, for transporting the lid therewith.

14. The lid conveyor according to claim 13, wherein the means for lid driving comprises a re-circulating chain driven by a drive assembly.

15. The lid conveyor according to claim 14, wherein the chain includes a plurality of chain links connected by linking pins.

16. The lid conveyor according to claim 15, wherein each of the chain links comprises substantially parallel and spaced apart link members that are connected by a cylindrical spacer at an end thereof.

17. The lid conveyor according to claim 16, wherein the peripheral portion of the lid engages the chain in the space provided between the cylindrical spacers between adjacent chain links.

18. The lid conveyor according to claim 14, wherein the chain further includes a plurality of engagement members attached thereto for engaging the peripheral portion of the lid.

19. The lid conveyor according to claim 13, wherein the means for lid driving comprises one of: i) a cable, or ii) a belt, arranged in an endless loop that is driven by a drive assembly, the one of: i) the cable, or ii) the belt including a plurality of lid engagement members thereon for engaging the peripheral portion of the lid.

20. The lid conveyor according to claim 14, further including an elongate channel member configured to provide a base frame for the conveyor, the channel member including upper chain guiding surface and a lower chain guiding surface.

21. The lid conveyor according to claim 20, further including a chain guide mounted to each side of the channel member, said chain guide extending above and below the upper and lower surfaces of the channel member, the chain guides being configured to provide, in conjunction with the upper and lower surfaces, a channel for guiding the chain along the conveyance path.

22. The lid conveyor according to claim 21, wherein the a means for lid guiding comprises at least one upper guide arranged along each side of the lid conveyance path and connected to the channel member.

23. The lid conveyor according to claim 22, wherein the a means for lid guiding further includes at least one lower guide arranged along both sides of the lid conveyance path and connected to the channel member.

24. The lid conveyor according to claim 21, wherein the upper and lower guides are configured to be positionally-adjustable.

25. A method for lid molding including the steps of:
molding a plurality of lids in an injection molding machine;
opening the injection mold to reveal the lids;
retrieving the lids from the injection mold using an in-mold lid handling system;
transferring the lids into at least one guide chute mounted to the injection mold, using the in-mold lid handling system;
closing and clamping of the injection mold;
substantially simultaneously to molding a subsequent plurality of lids, releasing the lids held in the at least one guide chute from the in-mold lid handling system so that the lids drop therein under the force of gravity;
transferring the lids into at least one lid conveyors that are aligned with the at least one guide chute beneath the at least drop chute, in the mold closed position, in a substantially vertical orientation;
conveying the lids from the injection molding machine.

26. The method for lid molding according to claim 25, further including the step of conveying the lids to a lid packing station.

27. The method for lid molding according to claim 25, further including the step of conveying the lids to at least one lid stacker.
